(19) United States
(12) Patent Application Publication
(10) Pub. No.: US 2008/0036806 A1
(43) Pub. Date: Feb. 14, 2008

(54) LIQUID INJECTING METHOD AND LIQUID CONTAINER

(75) Inventors: Satoshi SHINADA, Shiojiri-shi (JP); Chiaki MIYAJIMA, Matsumoto-shi (JP); Masahide MATSUYAMA, Higashichikuma-gun (JP); Yuichi SEKI, Matsumoto-shi (JP); Hisashi KOIKE, Suwa-shi (JP); Takayoshi KATSUMURA, Matsumoto-shi (JP)

Correspondence Address: SUGHRUE-265550, 2100 PENNSYLVANIA AVE. NW, WASHINGTON, DC, 20037-3213, US

(73) Assignee: SEIKO EPSON CORPORATION, Tokyo (JP)

(21) Appl. No.: 11/836,826

(22) Filed: Aug. 10, 2007

(30) Foreign Application Priority Data
Aug. 11, 2006 (JP) P2006-220755
Aug. 12, 2006 (JP) P2006-220759

(51) Int. Cl. B41J 29/38; B41J 2/175

(52) U.S. Cl. 347/9; 347/86

(57) ABSTRACT

A method of injecting a liquid into a liquid container detachably mounted on a liquid consuming device, the liquid container including a liquid containing portion, a liquid supply portion connectable to the liquid consuming device, a liquid guide path for guiding the liquid stored in the liquid containing portion to the liquid supply portion, an air communicating path communicating the liquid containing portion with air, a liquid detection unit provided in the liquid guide path and for outputting different signals between in a case where the liquid guide path is filled with the liquid and in a case where the liquid guide path includes air entered thereinto, and a dam portion provided in the liquid guide path so that an upper end thereof is disposed vertically above an inner-circumferential upper portion of a liquid inflow opening for allowing the liquid to flow in the liquid detection unit, the method includes the steps of: forming an injection port communicated with the liquid containing portion in the air communicating path; injecting a predetermined amount of the liquid from the injection port; and sealing the injection port after injecting the liquid.

### BACKGROUND

1. Technical Field

The present invention relates to a method of injecting a liquid in a liquid container of an open-air type that is suitable for an ink cartridge detachable from, for example, an ink jet printer and the like, and the liquid container.

2. Related Art

As an ink cartridge (liquid container) detachable from a liquid consuming device such as an ink jet printer, various kinds of open-air type ink cartridge are suggested. The open-air ink cartridge has, in a container body detachable from a printer, an ink containing portion (liquid containing portion) that contains ink, an ink supply portion (liquid supply portion) that is connected to a printing head (liquid ejecting portion), an ink guide path (liquid guide path) that guides the ink stored in the ink containing portion to the ink supply portion, and an air communicating path that introduces air into the ink containing portion from the outside with a consumption of the ink in the containing portion.

In such an ink cartridge, an ink residual quantity detecting mechanism (liquid detecting unit) in which a sensor having a piezoelectric vibrating body is disposed at a reference height in the liquid containing portion is provided (for example, see Patent Document 1). The liquid level of the ink stored in the liquid containing portion falls to the reference height with consumption by printing and outside air introduced from the air communicating path to the liquid containing portion according to ink consumption reaches a detection position of the sensor. Then, the ink residual quantity detection mechanism outputs different signals between when the periphery of the sensor fills with ink liquid and when the periphery of the sensor comes in contact with the air. The printer detects that the liquid level of the ink falls to the reference height based on the signals (change in residual vibration) output from the ink residual quantity detection mechanism.

That is, a change of acoustic impedance is detected by causing a piezoelectric device having a piezoelectric element or a vibrating portion of an actuator provided in the liquid containing portion to vibrate, subsequently by measuring a counter electromotive force generated by the residual vibration remaining in the vibrating portion, and by detecting an amplitude of a resonance frequency or a counter electromotive force waveform. The detected signal is used to display the residual quantity of ink or give notice of a cartridge replacement time.

Patent Document 1: JP-A-2001-146019

However, an ink cartridge is a container that includes multiple elements and is formed with a high precision. Accordingly, when ink is exhausted, the disposal of the ink cartridge results in a waste of a useful resource and a big economical loss. It is desirable that the used ink cartridge is re-used by re-injecting ink therein.

However, when the known ink cartridge is manufactured, an ink injecting step is included. Accordingly, after the ink cartridge is manufactured, there are many cases where the same ink injecting step cannot be used. As a result, it is necessary to develop a method of injecting ink in order to realize an ink-re-filling, instead of the ink injecting method at the time a new ink cartridge is manufactured.

A recent ink cartridge becomes high performance in that a differential pressure valve that adjusts an ink pressure to be supplied to the ink supply portion and also serves as a check valve for preventing the ink from flowing backward from an ink supply portion or an ink residual quantity detection mechanism for detecting an ink residual quantity is provided in an ink guide path allowing an ink containing chamber to communicate with the ink supply portion. Moreover, a configuration of the ink containing chamber or an air communicating path becomes complicated.

For this reason, if a container body is arranged carelessly, when ink is injected, a poor re-use may be caused. For example, the ink may leak into portions other than the ink containing portion or an original function may be damaged due to bubbles mixed when the ink is injected. For this reason, a re-use may be impossible.

In particular, when the bubbles floating in the injected ink are stuck to the surface of a sensor of the ink residual quantity detecting mechanism, the stuck bubbles may cause a change in residual vibration. Accordingly, whether the ink is present or not are not accurately detected, and thus it may be erroneously detected that the liquid level of the ink falls.

### SUMMARY

An advantage of some aspects of the invention is to provide a method of injecting a liquid into a liquid container into which the liquid can be injected without damage to a primary function of the liquid container, and the liquid container.

The advantage can be attained by at least one of the following aspects:

A first aspect of the invention provides a method of injecting a liquid into a liquid container detachably mounted on a liquid consuming device, the liquid container comprising a liquid containing portion, a liquid supply portion connectable to the liquid consuming device, a liquid guide path for guiding the liquid stored in the liquid containing portion to the liquid supply portion, an air communicating path communicating the liquid containing portion with air, a liquid detection unit provided in the liquid guide path and for outputting different signals between in a case where the liquid guide path is filled with the liquid and in a case where the liquid guide path includes air entered thereinto, and a dam portion provided in the liquid guide path so that an upper end thereof is disposed vertically above an inner-circumferential upper portion of a liquid inflow opening for allowing the liquid to flow in the liquid detection unit, the method comprising the steps of: forming an injection port communicated with the liquid containing portion in the air communicating path; injecting a predetermined amount of the liquid from the injection port; and sealing the injection port after injecting the liquid.

According to the method of injecting the liquid with the above-described configuration, the liquid injected from the injection port and passing through the liquid guide path passes through the dam portion, and then flows into the liquid inflow opening located at a portion lower than the upper end of the dam portion. At this time, when bubbles are mixed in the liquid passing through the dam portion, buoyancy acts on the bubbles upon approach to the liquid inflow opening due to the liquid filled in the liquid guide path. Accordingly, the bubbles rarely enter the liquid inflow opening.

The method of injecting the liquid may further comprise depressurizing an inside of the liquid containing chamber before injecting the liquid.

According to the method of injecting the liquids since the inside of the liquid containing chamber is depressurized in the depressurization process, the liquid can be effectively injected into the ink containing chamber in the subsequent ink injecting process.

In the method of injecting the liquid, the inside of the liquid containing chamber may depressurized through the liquid supply portion.

According to the method of injecting the liquid, specifically, when the liquid container is provided with a differential valve, the liquid can be injected up to a downstream of the differential valve.

In the method of injecting the liquid, the injection port may be formed in a downstream end of the air communicating path.

A second aspect of the invention provides a liquid container detachably mounted on a liquid consuming device includes: a liquid containing portion; a liquid supply portion connectable to the liquid consuming device; a liquid guide path for guiding the liquid stored in the liquid containing portion to the liquid supply portion; an air communicating path communicating the liquid containing portion with air; a liquid detection unit provided in the liquid guide path and for outputting different signals between in a case where the liquid guide path is filled with the liquid and in a case where the liquid guide path includes air entered thereinto; and a dam portion provided in the liquid guide path so that an upper end thereof is disposed vertically above an inner-circumferential upper portion of a liquid inflow opening for allowing the liquid to flow in the liquid detection unit, wherein an injection port communicated with the liquid containing portion is formed in the air communicating path, a predetermined amount of the liquid is injected from the injection port, and the injection port is sealed after injecting the liquid.

According to the liquid container with the above-described configuration, the liquid injected from the injection port and passing through the liquid guide path passes through the dam portion, and then flows into the liquid inflow opening located at a portion lower than the upper end of the dam portion. At this time, when bubbles are mixed in the liquid passing through the dam portion, buoyancy acts on the bubbles upon approach to the liquid inflow opening due to the liquid filled in the liquid guide path. Accordingly, the bubbles rarely enter the liquid inflow opening.

Further, when the liquid of the liquid guide path gradually decreases, a liquid level gradually falls from an upper end of the dam portion. Therefore, when a residual liquid exists in the liquid guide path, there is no case where the liquid level reaches the liquid inflow opening earlier.

In the liquid container with the above-described configuration, at least a part of a bottom surface of the liquid guide path between the liquid inflow opening and the dam portion may be vertically inclined toward the liquid inflow opening.

According to the configuration, when the liquid in the liquid guide path gradually decreases and the liquid level gradually falls from the upper end of the dam portion, the liquid distant from the liquid inflow opening gradually flows toward the liquid inflow opening along the inclined bottom surface.

That is, the discharge of the liquid becomes good, and the entire residual liquid is guided to the liquid inflow opening without the remaining of the liquid in the liquid guide path.

In the liquid container with the above-described configuration, a narrow flow passage causing a capillary phenomenon of the liquid may be formed in the liquid guide path.

According to the configuration, when the liquid in the liquid guide path enters the narrow flow passage, the liquid is sucked into the liquid inflow opening by the capillary phenomenon in addition to the liquid flow, and therefore a good liquid flow with no delay is obtained. Further, even when the termination of the liquid in the liquid guide path (a boundary between air and liquid) passes through the narrow flow passage, the liquid at the termination is guided to the liquid inflow opening by a suction action according to the capillary phenomenon without the remaining liquid at the termination.

In the liquid container with the above-described configuration, a plurality of the narrow flow passages may be formed in parallel.

According to the configuration, the suction action by the capillary phenomenon of the individual narrow flow passages is secured, and a large sectional area of a flow passage through which the liquid passes is secured. Accordingly, a head loss of the liquid can be minimized. Further, it is possible to reduce a possibility that a large bubble (or a boundary between air and liquid) reaches the liquid inflow opening compared with a case where one liquid guide path having the same flow passage sectional area is formed.

In the liquid container with the above-described configuration, the narrow flow passage may have a rectangular section.

According to the configuration, since a short side of the rectangular sectional shape is set sufficiently smaller than its long side, the flow passage becomes flat. Accordingly, it is possible to enhance a bubble inflow prevention effect, compared with a case the liquid guide path having the same flow passage sectional area is formed in a circular shape.

In the liquid container with the above-described configuration, an inlet portion on the uppermost stream side of the liquid guide path may be a round hole having a diameter larger than the short side length of the rectangular section of the narrow flow passage.

According to the configuration, the inlet portion of the liquid guide path is the round hole of which the diameter is lager than the short side of the rectangular sectional shape of the narrow flow passage. Accordingly, when a plurality of bubbles of which the diameter is equal or less than the short side of the rectangular sectional shape flow into the inlet portion, the bubbles can be combined with each other, and thus grown to have the same size as the round hole to the maximum, so that the bubbles rarely pass through the narrow flow passage. That is, when the inlet portion is formed to have a diameter equal to or less than the short side of the rectangular sectional shape, all the bubbles passing through the inlet portion enter the narrow flow passage. According to the above-described configuration, however, since the bubbles are grown to have a size not enough to pass through the narrow flow passage, the bubbles can be effectively prevented from entering the liquid inflow opening.

In the liquid container with the above-described configuration, at least one inner wall surface of the narrow flow passage may be an inner wall surface of the liquid guide path.

According to the configuration, since the inner wall surface of the narrow flow passage becomes the inner wall surface of the liquid guide path, a bubble which is brought in contact with the inner wall surface of the liquid guide path and which has a diameter not enough to enter the narrow flow passage becomes eccentric to the narrow flow passage.

That is, since the bubble is bound in the inner wall surface, the bubble is obliged to be asymmetrically deformed to a symmetry axis passing through the center. In this case, with the action of surface tension, the asymmetric deformation exhibits a larger restitution force of the bubble to a sphere than the symmetric deformation does. Accordingly, the bubble can rarely be sucked into the narrow flow passage. Namely, only the liquid can be easily guided into the narrow flow passage.

Since the inner wall surface of the narrow flow passage becomes the inner wall surface of the liquid guide path, a corner that is formed between the inner wall surfaces extends to the liquid guide path and the liquid inflow opening. Accordingly, the liquid in the narrow flow passage can be attracted to the liquid inflow opening by the capillary phenomenon occurring at the corner.

In the liquid container with the above-described configuration, a stepped portion in which the top surface on the downstream side is disposed vertically downward rather than that on the upstream side may be disposed in the liquid guide path.

According to the configuration, when the liquid injected from the injection port flows in the liquid guide path toward the liquid inflow opening, the liquid is caught at the stepped portion. Thus, when bubbles are mixed in the liquid, the bubbles are separated from the liquid, and the separated bubbles remain at the top surface above the stepped portion by buoyancy.

With this separation action, small bubbles that originally pass through the narrow flow passage can be grown to large bubbles that do not pass through the narrow flow passage, and thus bubbles are rarely stuck to the liquid detection unit.

A third aspect of the invention provides a liquid container detachably mounted on a liquid consuming device includes: a liquid containing portion; a liquid supply portion connectable to the liquid consuming device; a liquid guide path communicating the liquid containing portion and the liquid supply portion with each other; an air communicating path communicating the liquid containing portion with air; a liquid detection unit provided in the liquid guide path and for outputting different signals between in a case where the liquid guide path is filled with the liquid and in a case where the liquid guide path includes air entered thereinto; a dam portion provided in the liquid guide path so that an upper end thereof is disposed vertically above an inner-circumferential upper portion of a liquid inflow opening connecting a part of the liquid guide path to the liquid detection unit; a film member forming at least a part of the air communication path; and a sealing portion at which an injection port communicated with the liquid containing portion and formed on the film member is sealed.

In the liquid container with the above-described configuration, the sealing portion may be formed by a film or a tape.

In the liquid container with the above-described configuration, the liquid container may contain the liquid with such an amount that the liquid can flow over the dam portion.

### BRIEF DESCRIPTION OF THE DRAWINGS

The invention will be described with reference to the accompanying drawings, wherein like numbers reference like elements.

FIG. 1 is an exterior perspective view illustrating an ink cartridge which is an example of the liquid container according to an exemplary embodiment of the invention.

FIG. 2 is an exterior perspective view illustrating the ink cartridge according to the exemplary embodiment of the invention when viewed at an inverse angle in FIG. 1.

FIG. 3 is an exploded perspective view illustrating the ink cartridge according to the exemplary embodiment of the invention.

FIG. 4 is an exploded perspective view illustrating the ink cartridge according to the exemplary embodiment of the invention when viewed at an inverse angle in FIG. 3.

FIG. 5 is a view illustrating when the ink cartridge according to the exemplary embodiment of the invention is mounted on a carriage.

FIG. 6 is a sectional view illustrating the ink cartridge according to the exemplary embodiment of the invention immediately before the ink cartridge is mounted on the carriage.

FIG. 7 is a sectional view illustrating the ink cartridge according to the exemplary embodiment of the invention immediately after the ink cartridge is mounted on the carriage.

FIG. 8 is a diagram viewed from the front side surface of the cartridge body of the ink cartridge according to the exemplary embodiment of the invention.

FIG. 9 is a diagram viewed from the rear side surface of the cartridge body of the ink cartridge according to the exemplary embodiment of the invention.

FIG. 10(a) is a schematic diagram of the FIG. 8 and FIG. 10(b) is a schematic diagram of the FIG. 9.

FIG. 11 is a sectional view taken along the line A-A of FIG. 8.

FIG. 12 is a partly enlarged perspective view illustrating a configuration of flow passages shown in FIG. 8.

FIG. 13 an enlarged perspective view illustrating a major part shown in FIG. 8.

FIG. 14 is enlarged sectional view illustrating a major part shown in FIG. 13

FIG. 15 is a sectional perspective view taken along the line V-V shown in FIG. 14.

FIG. 16(a) is an explanatory view illustrating an asymmetric deformation in which a bubble becomes eccentric to a narrow flow passage, and FIG. 16(b) is an explanatory view illustrating symmetric deformation.

FIG. 17 is a block diagram illustrating a configuration of an ink re-injecting apparatus in which a method of injecting a liquid into an ink container according to the exemplary embodiment of the invention is performed.

### DESCRIPTION OF EXEMPLARY EMBODIMENTS

Hereinafter, a liquid injecting method and a liquid container according to an exemplary embodiment of the invention will be described in detail with reference to drawings. In the exemplary embodiment described below, as an exemplified liquid container, an ink cartridge mounted on an ink jet printing apparatus (printer), which is an example of a liquid ejecting apparatus, will be described.

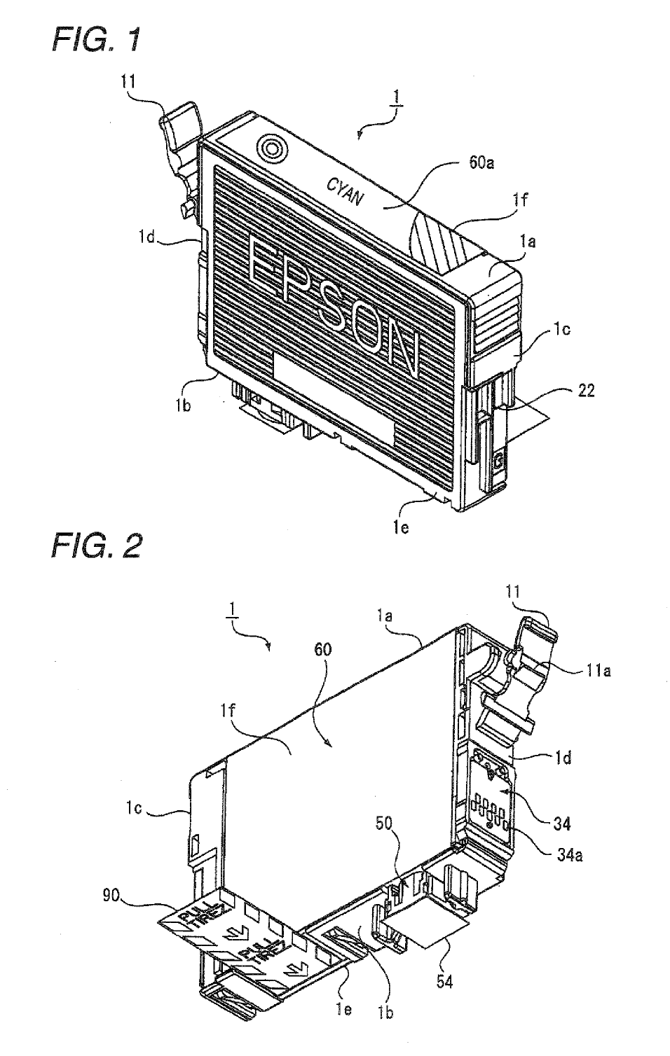

FIG. 1 is an exterior perspective view illustrating the ink cartridge which is an example of the liquid container according to an exemplary embodiment of the invention.

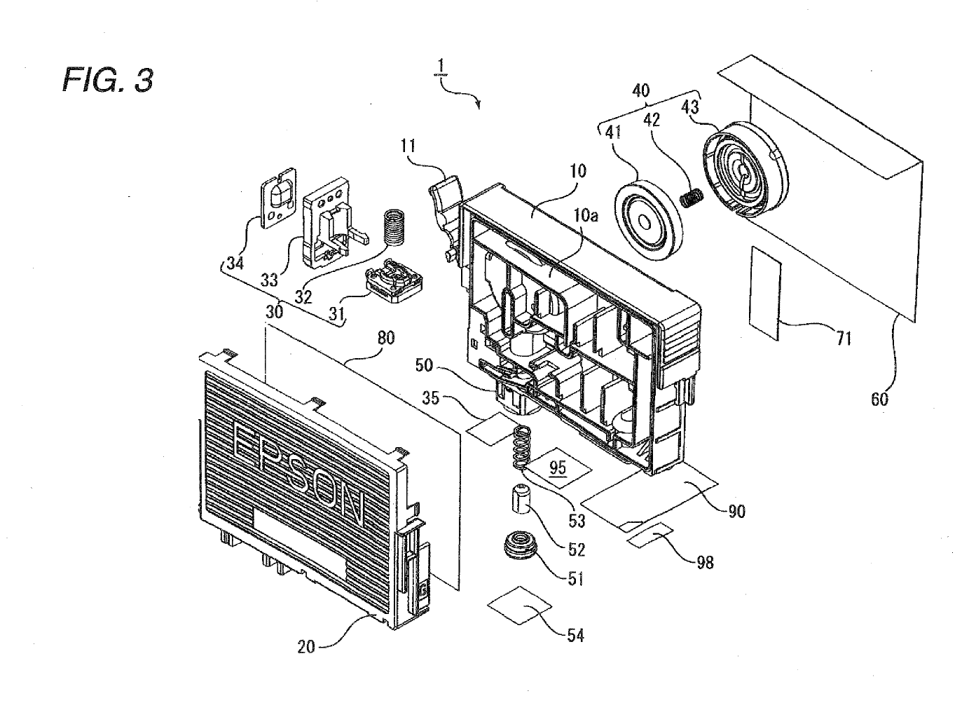

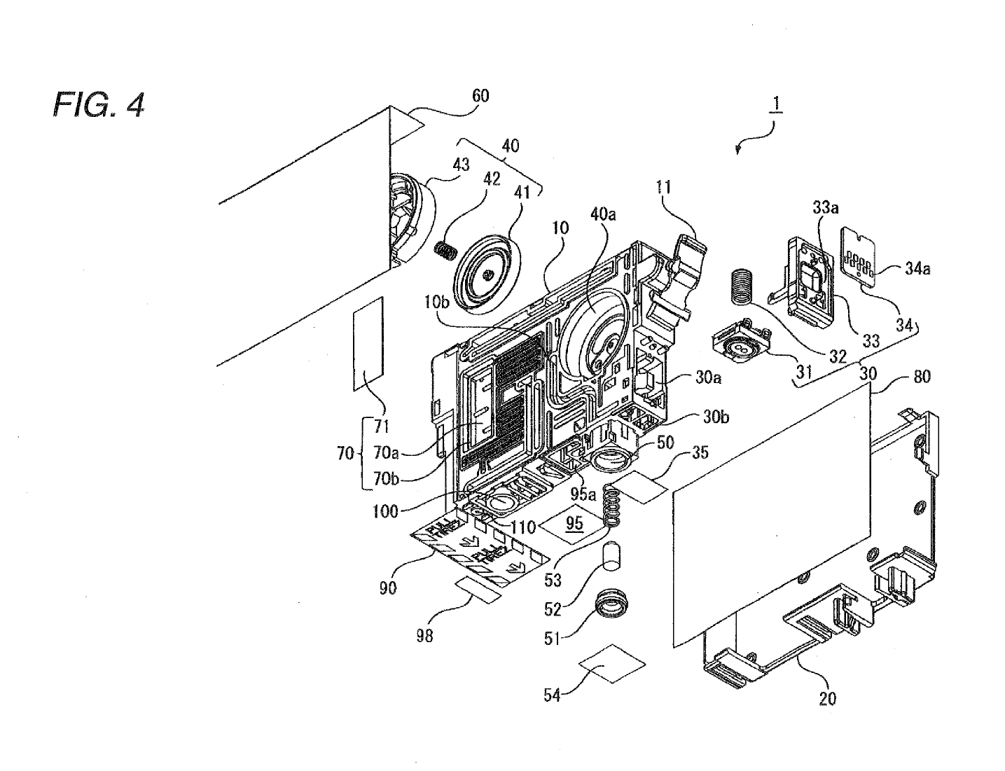

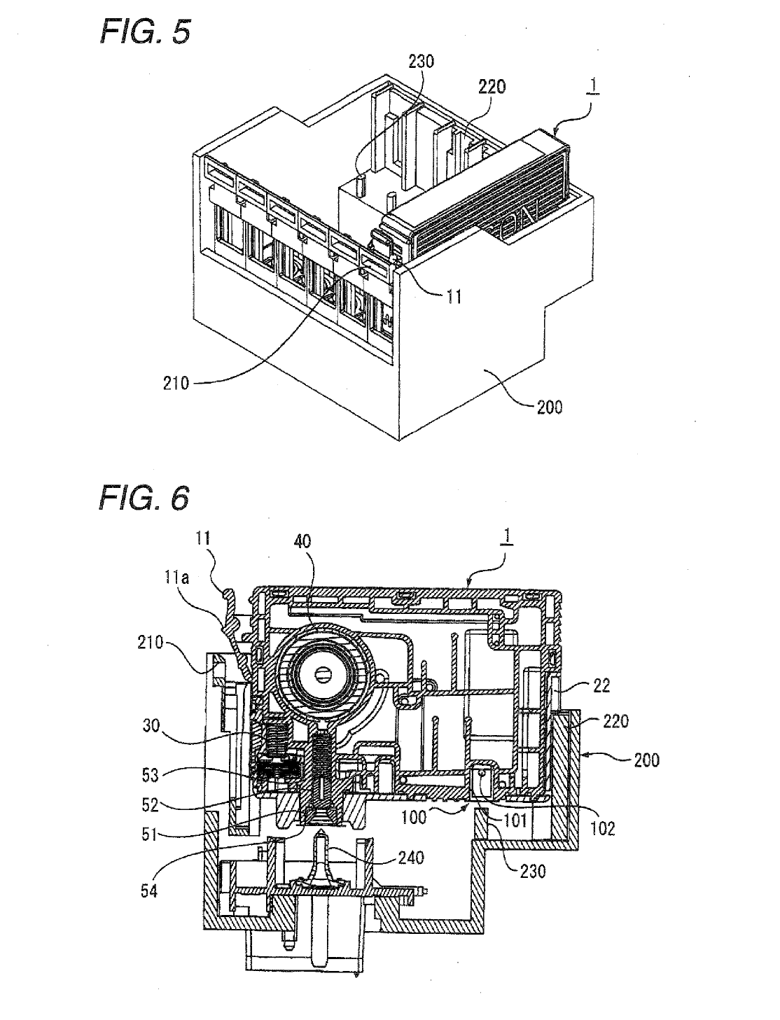

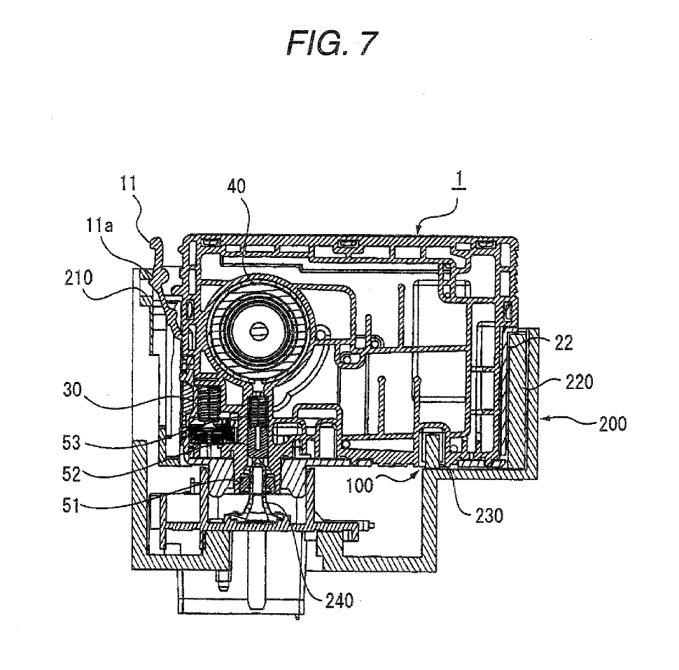

FIG. 2 is an exterior perspective view illustrating the ink cartridge according to the exemplary embodiment when viewed at an inverse angle in FIG. 1. FIG. 3 is an exploded perspective view illustrating the ink cartridge according to the exemplary embodiment. FIG. 4 is an exploded perspective view illustrating the ink cartridge according to the exemplary embodiment when viewed at an inverse angle in FIG. 3. FIG. 5 is a view illustrating when the ink cartridge according to the exemplary embodiment is mounted on a carriage. FIG. 6 is a sectional view illustrating the ink cartridge immediately before the ink cartridge is mounted on the carriage. FIG. 7 is a sectional view illustrating the ink cartridge immediately after the ink cartridge is mounted on the carriage.

As shown in FIGS. 1 and 2, an ink cartridge 1 according to the exemplary embodiment has a substantially rectangular parallelepiped shape and is the liquid container for storing/containing ink (liquid) I in an ink containing chamber (liquid containing portion) that is provided therein. The ink cartridge 1 is mounted on a carriage 200 of an ink jet printing apparatus that is an example of a liquid consuming device so as to supply the ink to the ink jet printing apparatus (see FIG. 5).

An outer appearance of the ink cartridge 1 will be described. As shown in FIGS. 1 and 2, the ink cartridge 1 has a flat upper surface 1a, and an ink supply portion (liquid supply portion) 50 that is connected to the ink jet printing apparatus to supply the ink is provide on a bottom surface 1b that is opposite to the upper surface 1a. Further, an air introducing hole 100 that communicates with the inside of the ink cartridge 1 for introducing air into the ink cartridge 1 opens in the bottom surface 1b.

That is, the ink cartridge 1 serves as an ink cartridge of an open-air type that provides ink from the ink supply portion 50 while introducing the air from the air introducing hole 100.

In the exemplary embodiment, the air introducing hole 100, as shown in FIG. 6, has a substantially cylindrical concave portion 101 that opens from the bottom surface toward the upper surface in the bottom surface 1b and a small hole 102 that opens in the inner circumference surface of the concave portion 101. Since the small hole 102 communicates with an air communicating path described below, the air is introduced into an upper ink containing chamber 370 (described below) positioned on an uppermost stream through the small hole 102.

The concave portion 101 of the air introducing hole 100 is formed in a position in which a protrusion 230 formed in the carriage 200 can be inserted. The protrusion 230 serves as a non-removing prevention protrusion for preventing a user from forgetting removal of a sealing film 90 that is means for air-tightly blocking the air introducing hole 100. That is, when the sealing film 90 is attached to the air introducing hole 100, the protrusion 230 cannot be inserted into the air introducing hole 100, and thus the ink cartridge 1 is not mounted on the carriage 200. Accordingly, even when a user tries to mount the ink cartridge 1 on the carriage 200 with the sealing film 90 attached to the air introducing hole 100, the ink cartridge 1 cannot be mounted. As a result, when the ink cartridge 1 is mounted, it is demanded that the sealing film 90 is reliably removed.

As shown in FIG. 1, an erroneous inserting prevention protrusion 22 for preventing the ink cartridge 1 from being mounted on an erroneous position is formed on a narrow side surface 1c adjacent to one end side of the upper surface 1a of the ink cartridge 1. As shown in FIG. 5, an uneven portion 220 corresponding to the erroneous inserting prevention protrusion 22 is formed on the carriage 200 which serves as a receiver. The ink cartridge 1 is mounted on the carriage 200 only when the erroneous inserting prevention protrusion 22 and the uneven portion 220 are not interfered with each other. The erroneous inserting prevention protrusion 22 has a different shape according to each kind of ink, and thus the uneven portion 220 on the carriage 200 which serves as the receiver has also a different shape according to the corresponding kind of ink. As a result, even when the plurality of ink cartridges is mounted on the carriage 200, as shown in FIG. 5, the ink cartridges may not be mounted on erroneous positions.

As shown in FIG. 2, an engagement lever 11 is provided on a narrow side surface 1d that is opposite to the narrow side surface 1c of the ink cartridge 1. A protrusion 11a that is engaged with a concave portion 210 formed in the carriage 200 when the ink cartridge 1 is mounted to the carriage 200 is formed in the engagement lever 11. Moreover, the protrusion 11a and the concave portion 210 are engaged with each other while the engagement lever 11 is bent so that the ink cartridge 1 is fixed on the carriage 200.

A circuit board 34 is provided below the engagement lever 11. A plurality of electrode terminals 34a are formed on the circuit board 34. Since the electrode terminals 34a comes in contact with an electrode member (not shown) provided in the carriage 200, the ink cartridge 1 is electrically connected with the ink jet printing apparatus. A nonvolatile memory capable of rewriting data is provided in the circuit board 34. Various data about the ink cartridge 1, ink use data of the ink jet printing apparatus, or the like are memorized in the nonvolatile memory. An ink residual quantity sensor 31 (liquid detection unit) for detecting an amount of residual ink in the ink cartridge 1 using residual vibration is provided in the back of the circuit board 34 (see FIG. 3 or 4). Hereinafter, the ink residual quantity sensor 31 and the circuit board 34 are called an ink end sensor 30

As shown in FIG. 1, a label 60a for denoting a content of an ink cartridge is attached to the upper surface 1a of the ink cartridge 1. The edge of an outer surface film 60 that covers a wide side surface 1f is extended and attached to the upper surface 1a so that the label 60a is formed.

As shown in FIGS. 1 and 2, the wide side surfaces 1e and 1f adjacent two long sides of the upper surface 1a of the ink cartridge 1 are formed in a flat surface shape. Hereinafter, a side of the wide side surface 1e, a side of the wide side surface 1f, a side of the narrow side surface 1c, and a side of the narrow side surface 1d denote a front side surface, a rear side surface, a right side surface, and a left side surface, respectively for convenience' sake.

Next, each portion constituting the ink cartridge 1 will be described with reference to FIGS. 3 and 4.

The ink cartridge 1 has a cartridge body 10 that is the container body and a cover member 20 for covering the front side surface of the cartridge body 10.

Ribs 10a that have various shapes are formed in the front side surface of the cartridge body 10. In order to form walls, the ribs 10a partition a plurality of the ink containing chambers (liquid containing portion) that fill with the ink I, a non-containing chamber which does not fill with the ink I, an air chamber that is positioned in a way of the air communicating path 150 described below, and so on in the inside of the cartridge body 10.

A film 80 that covers the front side surface of the cartridge body 10 is provided between the cartridge body 10 and the cover member 20. The film 80 covers the upper surfaces of the ribs, concave portions, grooves so that a plurality of flow passages, the ink containing chambers, the non-containing chamber, the air chamber are formed.

In the rear side surface of the cartridge body 10, a concave-shaped differential pressure valve accommodating chamber 40a accommodating a differential pressure valve 40 and a concave-shaped gas-liquid separating chamber 70a constituting a gas-liquid separating filter 70 are formed.

A valve member 41, a spring 42, and a spring seat 43 are accommodated in the differential pressure valve accommodating chamber 40a and constitute the differential pressure valve 40. The differential pressure valve 40 is disposed between the ink supply portion 50 positioned on the downstream and the ink containing chamber positioned on the upstream, and is urged to a closed state in which the ink flow from a side of the ink containing chamber to a side of the ink supply portion 50 is blocked. The differential pressure valve 40 is configured so that when a differential pressure between the side of the ink containing chamber and the side of the ink supply portion 50 becomes a predetermined value or more depending on ink supply from the ink supply portion 50 to the printer, the differential valve 40 is changed from the closed state to the opened state and the ink I is supplied to the ink supply portion 50.

On the upper surface of the gas-liquid separating chamber 70a, a gas-liquid separating film 71 is attached along a dam 70b surrounding an outer circumference provided in the vicinity of the middle portion of the gas-liquid separating chamber 70a. The gas-liquid separating film 71 is made of a material that passes a gas, but does not pass a liquid. The gas-liquid separating film 71 constitutes the gas-liquid separating filter 70. The gas-liquid separating filter 70 is provided within the air communicating path 150 that connects the air introducing hole 100 to the ink containing chamber, and allows the ink I in the ink containing chamber not to leak to the air introducing hole 100 through the air communicating path 150.

In the rear side surface of the cartridge body 10, a plurality of grooves 10b are carved in addition to the differential pressure accommodating chamber 40a and the gas-liquid separating chamber 70a. Since the outer surface film 60 covers the outer surface in a state where the differential pressure valve 40 and the gas-liquid separating filter 70 are formed, the opening of each groove b is blocked, and thus the air communicating path 150 or the ink guide path (liquid guide path) is formed.

As shown in FIG. 4, a concave-shaped sensor chamber 30a that accommodates each member constituting the ink end sensor 30 is formed in the right side surface of the cartridge body 10. The ink residual quantity sensor 31 and a compressing spring 32 for pressing the residual quantity sensor 31 against the inner wall of the sensor chamber 30a are accommodated in the sensor chamber 30a. The opening of the sensor chamber 30a is covered with a cover member 33 so that the circuit board 34 is fixed on an outer surface 33a of the cover member 33. A sensing member of the ink residual quantity sensor 31 is connected to the circuit hoard 34.

The ink residual quantity sensor 31 includes a cavity forming a part of the ink guide path between the ink containing chamber and the ink supply portion 50, a vibrating plate forming a part of the wall surface of the cavity, and a piezoelectric element (piezoelectric actuator) allowing vibration to be applied onto the vibrating plate. The ink residual quantity sensor 31 outputs residual vibration at the time of applying the vibration onto the vibrating plate to the printer as signals. Then the printer detects whether the ink I exists in the ink guide path from the signals output from the ink residual quantity sensor 31. The printer detects a difference in an amplitude, a frequency, or the like of the residual vibration between the ink I and the gas (bubble B mixed in the ink) based on the signals output from the ink residual quantity sensor 31 so as to detect whether the ink I exists in the cartridge body 10.

Specifically, when the ink I of the ink containing chamber in the cartridge body 10 is exhausted or is lowered to a predetermined amount, air introduced into the ink containing chamber passes through the ink guide path and enter into the cavity of the ink residual quantity sensor 31. At this time, the printer detects the change in the amplitude or the frequency of the residual vibration based on the signals output from the ink residual quantity sensor 31 and outputs an electrical signal for denoting the ink end or ink near end.

As shown in FIG. 4, a depressurization hole 110 used to depressurize the ink cartridge 1 by sucking air from the inside thereof by vacuuming means when the ink is injected, a concave portion 95a constituting the ink guide path from the ink containing chamber to the ink supply portion 50, and a buffer chamber 30b provided below the ink end sensor 30 are provided on the bottom surface of the cartridge body 10 in addition to the ink supply portion 50 and the air introducing hole 100 described above.

Immediately after the ink cartridge is manufactured, openings of the ink supply portion 50, the air introducing hole 100, the depressurization hole 110, the concave portion 95a, and the buffer chamber 30b are sealed by sealing films 54, 90, 98, 95, 35, respectively. The sealing film 90 for sealing the air introducing hole 100 is removed by a user before the ink cartridge is mounted on the ink jet printing apparatus to be used. Accordingly, the air introducing hole 100 is exposed to the outside so that the ink containing chamber in the ink cartridge 1 is allowed to communicate with open air by the air communicating path 150.

The sealing film 35 attached onto the outer surface of the ink supply portion 50, as shown in FIGS. 6 and 7, is configured so as to be torn by an ink supply needle 240 of the ink jet printing apparatus when mounted on the ink jet printing apparatus.

As shown in FIGS. 6 and 7, a ring-shaped sealing member 51 that is pressed against the outer surface of the ink supply needle 240 when mounted on a printer, a spring seat 52 that comes in contact with the sealing member 51 to block the ink supply portion 50 when not mounted on the printer, and a compressing spring 53 that urges the spring seat 52 in a direction of coming in contact with the sealing member 51 are included within the ink supply portion 50.

As shown in FIGS. 6 and 7, the ink supply needle 240 is inserted into the ink supply portion 50. At this time, the inner circumference of the sealing ember 51 and the outer circumference of the ink supply needle 240 are sealed with each other, a gap between the ink supply portion 50 and the ink supply needle 240 is sealed liquid-tightly. In addition, the front end of the ink supply needle 51 comes in contact with the spring seat 52 and pushes up the spring seat 52. At this time, since the spring seat 52 and the sealing member 51 are released from each other, the ink can be supplied from the ink supply portion 50 to the ink supply needle 240.

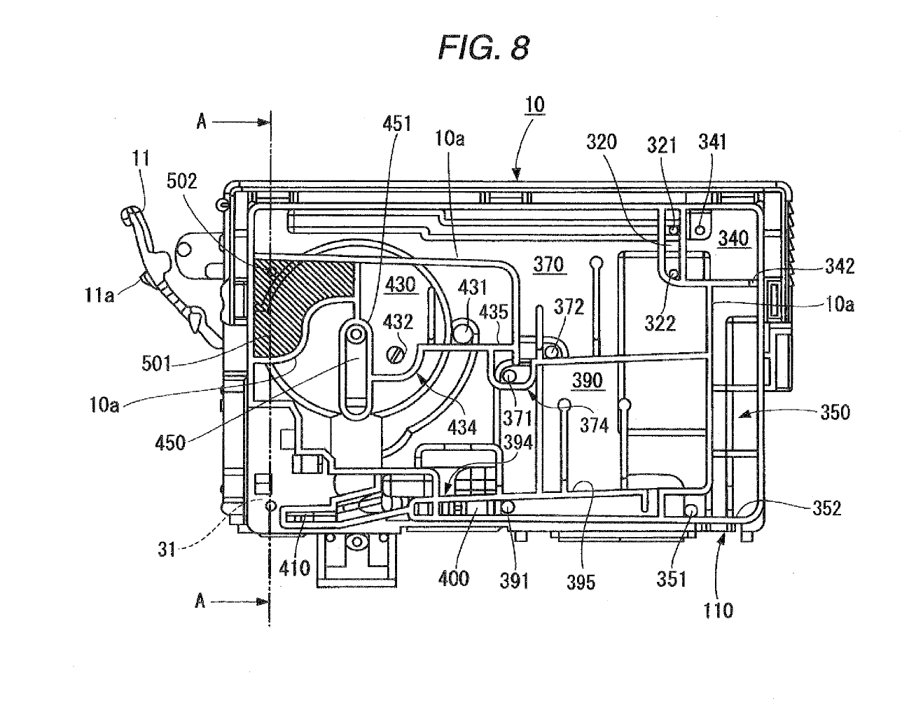

Next, the inner configuration of the ink cartridge 1 according to the exemplary embodiment will be described with reference to the FIGS. 8 to 12.

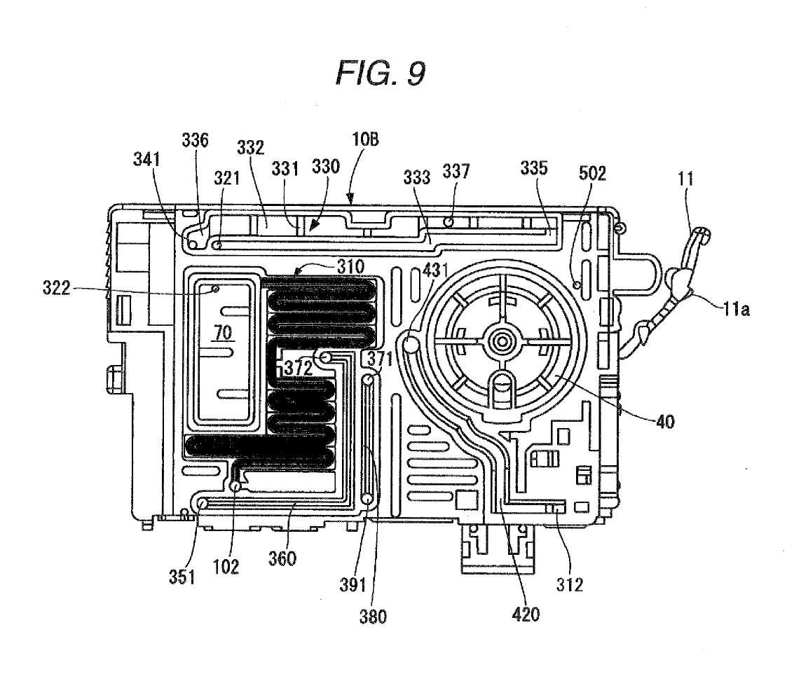

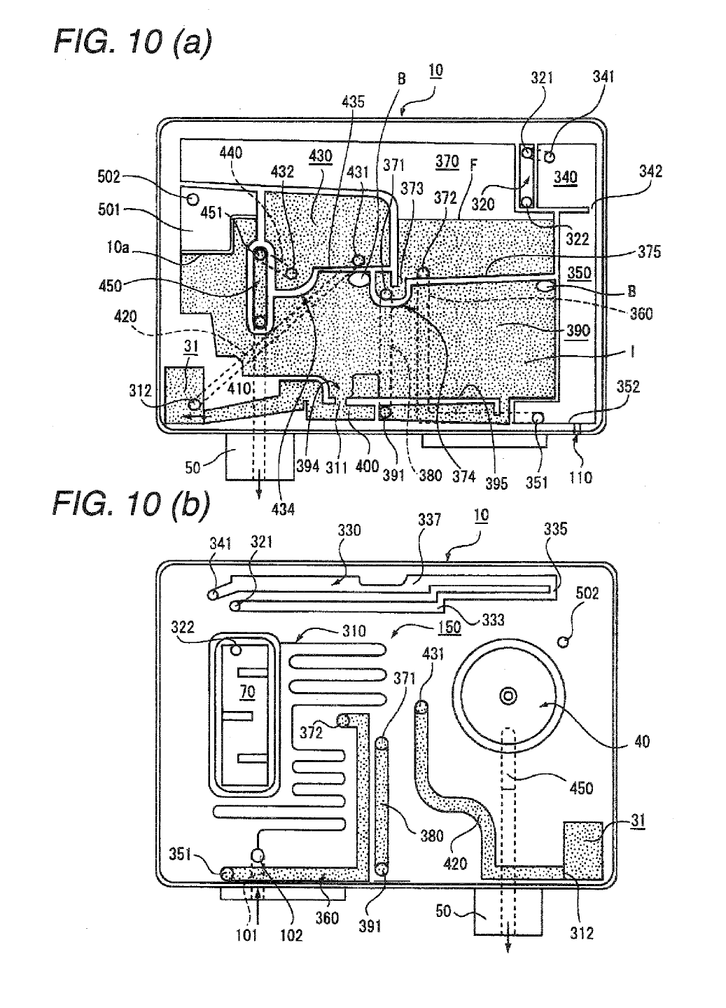

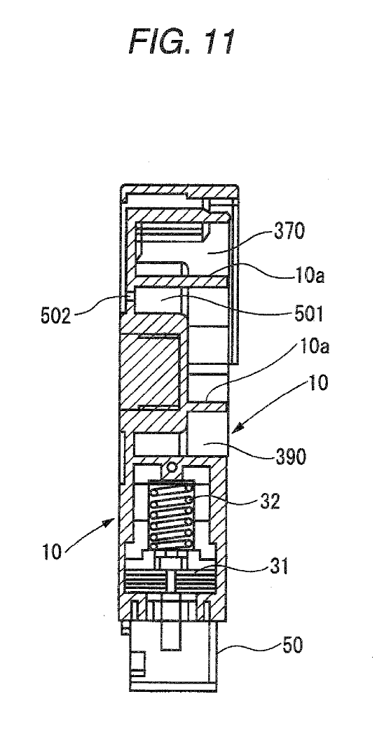

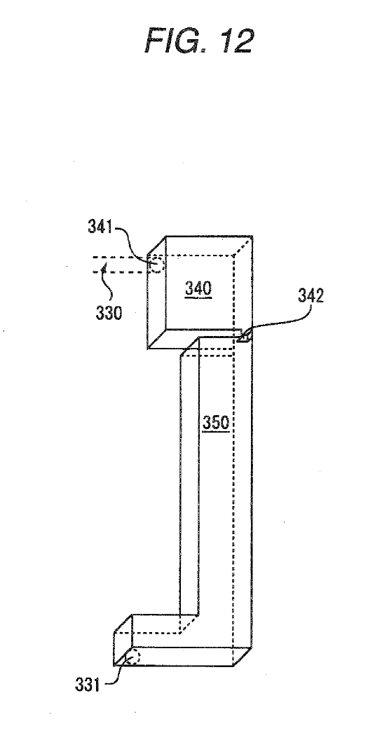

FIG. 8 is a diagram viewed from the front side surface of the cartridge body 10 of the ink cartridge 1 according to the exemplary embodiment. FIG. 9 is a diagram viewed from the rear side surface of the cartridge body 10 of the ink cartridge 1 according to the exemplary embodiment. FIG. 10(a) is a schematic diagram of the FIG. 8 and FIG. 10(b) is a schematic diagram of the FIG. 9, FIG. 11 is a sectional view taken along the line A-A of FIG. 8. FIG. 12 is a partly enlarged perspective view illustrating a flow passage shown in FIG. 8.

In the ink cartridge 1 according to the exemplary embodiment, three ink containing chambers, that is, the upper ink containing chamber 370 and a lower ink containing chamber 390 as primary ink containing chambers for filling with the ink I, and the buffer chamber 430 which is positioned so as to be interposed therebetween are formed in the front side surface of the cartridge body 10 (see FIG. 10).

Further, in the rear side surface of the cartridge body 10, the air communicating path 150 introducing air into the upper ink containing chamber 370, which is the ink containing chamber positioned on the uppermost stream, according to a consumption amount of the ink I, is formed.

The ink containing chambers 370 and 390 and the buffer chamber 430 are partitioned by a rib 10a. According to the exemplary embodiment, in each ink containing chamber, recesses 374, 394, and 434 having a caved-in shape downward are formed in a part of the rib 10a that horizontally extend so as to be bottom walls of the ink containing chambers.

The recess 374 is formed in the manner that a part of a bottom wall 375 formed by the rib 10a of the upper ink containing chamber 370 is caved in downward. The recess 394 is formed in the manner that a bottom wall 395 formed by the rib 10a of the lower ink containing chamber 390 and a bulge of the wall surface are caved in a thicknesswise direction of the cartridge. The recess 434 is formed in the manner that a part of a bottom wall 435 formed by the rib 10a of the buffer chamber 430 is caved in downward.

Moreover, ink discharging ports 371, 311, and 432 that communicate with the ink guide path 380, an upstream ink end sensor connecting flow passage 400, and an ink guide path 440 are provided in bottom portions or the vicinity of the recesses 374, 394, and 434, respectively.

The ink discharging ports 371 and 432 are through-holes that penetrates the wall surface of each ink containing chamber in the thicknesswise direction of the cartridge body 10. In addition, the ink discharging port 311 is a through-hole that penetrates the bottom wall 395 downward.

One end portion of the ink guide path 380 communicates with the ink discharging port 371 of the upper ink containing chamber 370 while the other end portion thereof communicates with an ink inflow port 391 provided in the lower ink containing chamber 390. In this way, the ink guide path 380 serves as a communicating flow passage for guiding the ink I contained in the upper ink containing chamber 370 to the lower ink containing chamber 390. The ink guide path 380 is provided so as to extend from the ink discharging port 371 of the upper ink containing chamber 370 vertically downward. Accordingly, the ink guide path 380 allows the pair of the ink containing chambers 370 and 390 to be connected with each other so that the ink I descends from upstream side to downstream side.

One end portion of the ink guide path 420 communicates with the ink discharging port 312 of the cavity of the ink residual quantity sensor 31 positioned on the downstream of the lower ink containing chamber 390 while the other end thereof communicates with an ink inflow port 431 provided in the buffer chamber 430. Accordingly, the ink guide path 420 guides the ink I contained in the lower ink containing chamber 390 to the buffer chamber 430. The ink guide path 420 is provided so as to extend obliquely upward from the ink discharging port 312 of the cavity in the ink residual quantity sensor 31. Accordingly, the ink guide path 420 allows the pair of the ink containing chambers 390 and 430 to be connected with each other so that the ink I ascends from upstream side to downstream side.

That is, in the cartridge body 10 according to the exemplary embodiment, the three ink containing chambers 370, 390, and 430 are allowed to be alternatively connected in series to each other so that the ink I descends or ascends.

The ink guide path 440 serves as an ink flow passage that allows the ink discharging port 432 of the buffer chamber 430 to guide the ink to a differential valve 40.

In this exemplary embodiment, the ink inflow ports 391 and 431 of the ink containing chambers are provided so as to be positioned above the ink discharging port 371 and 311 provided in the ink containing chambers and in the vicinities of the bottom walls 375, 395, and 435 of the ink containing chambers.

First, the ink guide path from the upper ink containing chamber 370, which is a primary ink containing chamber, to the ink supply portion 50 will be described below with reference to FIGS. 8 to 12.

The upper ink containing chamber 370 is an ink containing chamber positioned on the uppermost stream (the uppermost portion) in the cartridge body 10. As shown in FIG. 8, the upper ink containing chamber 370 is formed on the front side surface of the cartridge body 10. The upper ink containing chamber 370 occupies about the half of an ink contained area of the ink containing chambers and is formed above the substantial half of the cartridge body 10a.

The ink discharging port 371 that communicates with the ink guide path 380 opens in the recess 374 of the bottom wall 375 of the upper ink containing chamber 370. The ink discharging 371 is positioned below the bottom wall 375 of the upper ink containing chamber 370. Even when an ink level F within the upper ink containing chamber 370 falls up to the bottom wall 375, the ink discharging port 371 is positioned lower than the ink level F. Accordingly, the ink I continues to be stably discharged.

As shown in FIG. 9, the ink guide path 380 that is formed on the rear side surface of the cartridge body 10 allows the ink I to flow from the upper portion to the lower ink containing chamber 390.

The lower ink containing chamber 390 is an ink containing chamber into which the ink I stored in the upper ink containing chamber 370 is introduced. Moreover, as shown in FIG. 8, the lower ink containing chamber 390 occupies about the half of the ink contained area of the ink containing chambers formed on the front side surface of the cartridge body 10, and is formed below the substantial half of the cartridge body 10.

The ink inflow port 391 that communicates with the ink guide path 380 opens to a communicating flow passage disposed below the bottom wall 395 of the lower ink containing chamber 390. Accordingly, the ink I flows from the upper ink containing chamber 370 through the communicating flow passage.

An ink discharging port 311 that penetrates the bottom wall 395 allows the lower ink containing chamber 390 to communicate with the upstream ink end sensor connecting flow passage 400. A three-dimensional labyrinthine flow passage is formed in the upstream ink end sensor connecting flow passage 400. Accordingly, bubble B or the like that flow to the labyrinthine flow passage before the ink ends are caught so as not to flow toward the downstream.

The upstream ink end sensor connecting flow passage 400 communicates with a downstream ink end sensor connecting flow passage 410 through an ink inlet portion 427 that is a through-hole. Moreover, the ink I is guided to flow to the ink residual quantity sensor 31 through the downstream ink end sensor connecting flow passage 410.

The ink I guided to flow to the ink residual quantity sensor 31 is guided to flow from the ink discharging port 312, which is an outlet port of the cavity, to the ink guide path 420, which is formed on the rear side surface of the cartridge body 10, through the cavity (flow passage) within the liquid residual quantity sensor 31.

Since the ink guide path 420 is formed obliquely upward from the liquid residual quantity sensor 31 so as to allow the ink I to flow upward, the ink guide path 420 is connected to the ink inflow port 431 that communicates with the buffer chamber 430. Accordingly, the ink I that comes out of the ink residual quantity sensor 31 is guided to flow into the buffer chamber 430 through the ink guide path 420.

The buffer chamber 430 is a small room that is partitioned by the rib 10a between the upper ink containing chamber 370 and the lower ink containing chamber 390 and serves as a space for storing the ink immediately before the differential pressure valve 40. The buffer chamber 430 is formed so as to be opposite to the rear side of the differential pressure valve 40. Accordingly, the ink I flows to the differential pressure valve 40 through the ink guide path 440 that communicates with the ink discharging port 432 formed in the recess 434 of the buffer chamber 430.

The ink I that flows to the differential pressure valve 40 is guided to flow to the downstream by the differential pressure valve 40, and then is guided to an outlet flow passage 450 through a through-hole 451. Since the outlet flow passage 450 communicates with the ink supply portion 50, the ink I is supplied to the ink jet printing apparatus through the ink supply needle 240 inserted into the ink supply portion 50.

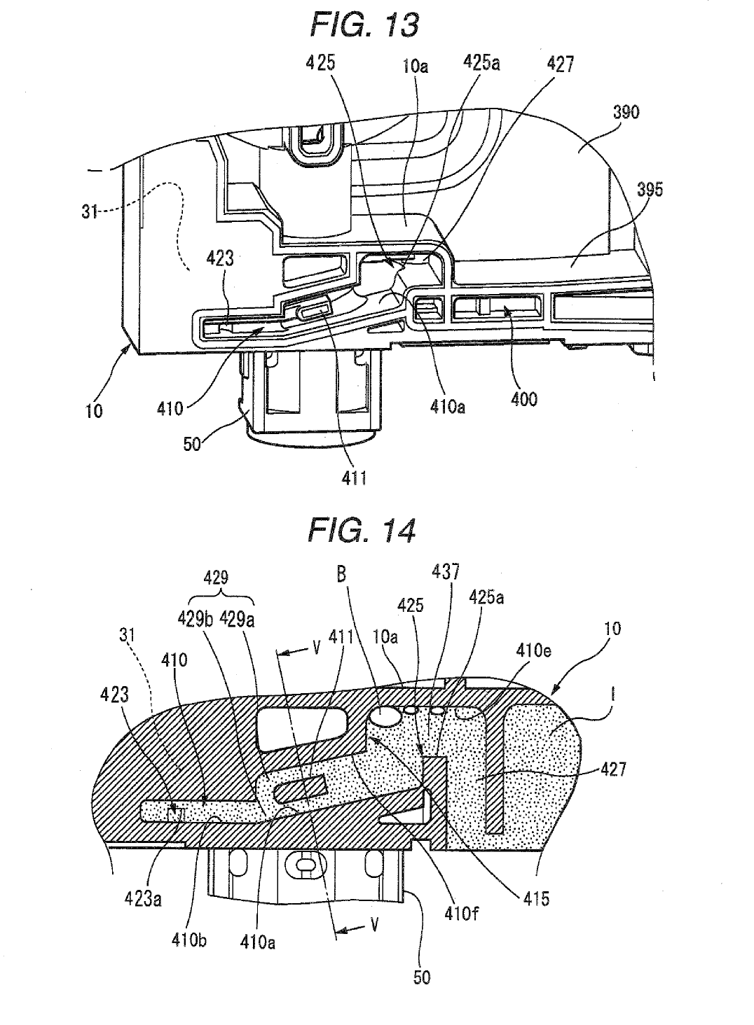

In the downstream ink end sensor connecting flow passage (liquid guide path) 410 according to the exemplary embodiment, as shown in FIGS. 13 and 14, there is provided a dam portion 425 of which an upper end 425a is disposed vertically upper than an inner circumference upper portion 423a of an ink inflow opening 423 that allows the ink I to flow in a sensor chamber provided with the ink residual quantity sensor 31. In the exemplary embodiment, the ink inlet portion 427 describe below is formed in the right end of the downstream ink end sensor connecting flow passage 410 shown in FIG. 14, and an ink inflow opening 423 is formed in the left end thereof.

In this case, the ink I in the downstream ink end sensor connecting flow passage 410 flows toward the upper portion of the ink inlet portion 427, and then flows into the ink inflow opening 423 that is in the left end beyond the dam portion 425. After the ink I that passes through the downstream ink end sensor connecting flow passage 410 passes through the dam portion 425, the ink I flows into the ink inflow opening 423 that is lower than the upper end 425a of the dam portion 425.

Accordingly, when the bubble B is mixed in the ink I passing through the dam portion 425, buoyancy acts against the bubble B upon the approach to the ink inflow opening 423 by the ink I that is filled in the downstream ink end sensor connecting flow passage 410. Then, the bubble B rarely enters the ink inflow opening 423. Further, when the ink I in the downstream ink end sensor connecting flow passage 410 gradually decreases, a liquid level gradually falls from the upper end 425a of the dam portion 425. Therefore, when a residual liquid exists in the downstream ink end sensor connecting flow passage 410, there is no case where the liquid level reaches the ink inflow opening 423 earlier.

At least a part of the downstream ink end sensor connecting flow passage 410 between the ink inflow opening 423 and the dam portion 425 has a bottom surface 410a that is inclined vertically downward toward the ink inflow opening 423. In the exemplary embodiment, a horizontal bottom surface 410b is formed between the bottom surface 410a and the ink inflow opening 423. Alternatively, the horizontal bottom surface 410b may be omitted and the bottom surface 410a may be directly connected to the ink inflow opening 423.

With the inclined bottom surface 410a, when an amount of the ink of the downstream ink end sensor connecting flow passage 410 gradually decreases, and the liquid level gradually falls from the upper end 425a of the dam portion 425, the ink I distant from the ink inflow opening 423 gradually flows toward the ink inflow opening 423 along the inclined bottom surface 410a. That is, the discharge of the ink I becomes good, and the entire residual ink is guided to the ink inflow opening 423 without remaining in the downstream ink end sensor connecting flow passage 410.

A narrow flow passage 429 is formed above the bottom surface 410a of the downstream ink end sensor connecting flow passage 410 so as to cause a capillary phenomenon of the ink I. With the narrow flow passage 429, when the ink I enters the narrow flow passage 429 beyond the dam portion 425, the ink I is sucked into the ink inflow opening 423 by a liquid flow and the capillary phenomenon, and thus a good liquid flow with no delay is obtained.

When the termination of the ink in the downstream ink end sensor connecting flow passage 410 (boundary between gas and liquid) passes through the narrow flow passage 429, the ink I at the termination is reliably guided to the ink inflow opening 423 by a suction action according to the capillary phenomenon, without remaining at the termination.

The narrow flow passage 429 is provided with a partition wall piece 411 that is formed in the downstream ink end sensor connecting flow passage 410 above the bottom surface 410a, so that two small flow passages 429a and 429b are formed. That is, the narrow flow passage 429 has a plurality of small flow passages 29a and 29b that are arranged in parallel.

With the small flow passages 429a and 429b of the narrow flow passage 429, the suction action is secured by the individual capillary phenomenon, and a large sectional area of a flow passage through which the ink I passes is secured. Accordingly, a head loss of the ink I can be reduced. Further, it is possible to reduce a possibility that a large bubble (or a boundary between gas and liquid) reaches the ink inflow opening 423, compared with a case where the downstream ink end sensor connecting flow passage 410 having the same flow passage sectional area is formed in one sectional shape.

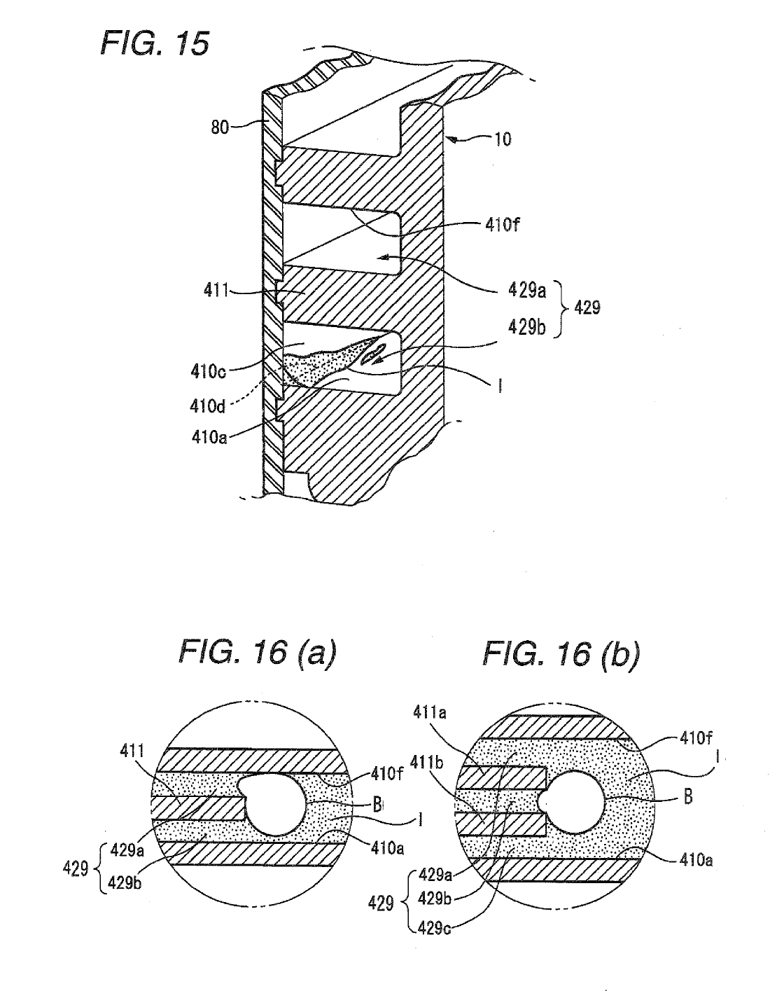

In the exemplary embodiment, as shown in FIGS. 15 and 16, the small flow passages 429a and 429b of the narrow flow passage 429 are formed in a rectangular sectional shape.

Since a short side of the rectangular sectional shape is set sufficiently smaller than the long side thereof in this way, the flow passage becomes flat. Accordingly, it is possible to enhance a bubble B inflow prevention effect of the ink I, compared with a case the downstream ink end sensor connecting flow passage 410 having the same flow passage sectional area is formed in a circular shape. In addition, as shown in FIGS. 13 and 14, the ink inlet portion 427 positioned on the uppermost stream side of the downstream ink end sensor connecting flow passage 410 is a round hole having a diameter larger than the short side of the rectangular sectional shape of the narrow flow passage 429. The ink I flowing into the downstream ink end sensor connecting flow passage 410 passes through the ink inlet portion 427 upward, and then flows into the narrow flow passage 429 beyond the dam portion 425.

In this way, the ink inlet portion 427 of the downstream ink end sensor connecting flow passage 410 is the round hole having a diameter larger than the short side of the rectangular sectional shape of the narrow flow passage 429. Accordingly, when a plurality of bubbles each having a diameter equal to or less than the short side of the rectangular sectional shape flow into the ink inlet portion 427, the bubbles can be combined with each other and grown to have the same size as the round hole to the maximum, so that the bubble B in the ink I rarely passes through the narrow flow passage 429. That is, when the ink inlet portion 427 is formed to have a diameter equal to or less than the short side of the rectangular sectional shape, all the bubble B passing through the ink inlet portion 427 enter the narrow flow passage 429. According to the above-described configuration, however, since the bubble B is grown to have a size not enough to pass through the narrow flow passage 429, the bubble B in the ink I can be effectively prevented from entering the ink inflow opening 423.

As shown in FIG. 15, at least one of inner wall surfaces in the small flow passage 429a constituting the narrow flow passage 429 also serves as a top surface 410f that is an inner wall surface of the downstream ink end sensor connecting flow passage 410. Further, one inner wall surface in the small flow passage 429b constituting the narrow flow passage 429 becomes the bottom surface 410a that is an inner wall surface of the downstream ink end sensor connecting flow passage 410, and is connected to the horizontal bottom surface 410b.

In this way, one inner wall surface in each of the small flow passages 429a and 429b constituting the narrow flow passage 429 also serves as the top surface 410f or the bottom surface 410a that is the inner wall surface of the downstream ink end sensor connecting flow passage 410. For example, as shown in FIG. 16(a), the bubble B in the ink I, of which the outer circumference is brought into contact with the top surface 410f of the downstream ink end sensor connecting flow passage 410 and which has a diameter not enough to enter the small flow passage 429a, becomes eccentric to the small flow passage 429a.

That is, since the bubble B is brought into contact with and bound by the top surface 410f of the downstream ink end sensor connecting flow passage 410, the bubble B is forced to be deformed asymmetrically to a symmetry axis passing through the center.

In contrast, for example, as shown in FIG. 16(b), when the narrow flow passage 429 has a small flow passage 429c that is formed by a pair of partition wall pieces 411a and 411b, one inner wall surface of the small flow passage 429c does not serve as the top surface 410f or the bottom surface 410a of the downstream ink end sensor connecting flow passage 410.

The bubble B in the ink I having a diameter not enough to enter the small flow passage 429c becomes concentric to the small flow passage 429c, and is deformed symmetrically to a symmetry axis passing through the center.

Therefore, with the action of surface tension, the asymmetric deformation shown in FIG. 16(a) exhibits a larger restitution force of the bubble B to a sphere than the symmetric deformation does as shown in FIG. 16(b). Accordingly, the bubble B in the ink I is enabled to be rarely sucked into the small flow passage 429a. Namely, only the ink I can easily enter the narrow flow passage 429.

The inner wall surface of the small flow passage 429b becomes the bottom surface 410a of the downstream ink end sensor connecting flow passage 410 and is connected to the horizontal bottom surface 410b. Then, as shown in FIG. 15, a corner 410d that is formed between the bottom surface 410a and the inner wall 410c extends to the downstream ink end sensor connecting flow passage 410 and the ink inflow opening 423. Accordingly, the ink I in the narrow flow passage 429 can be attracted to the ink inflow opening 423 by the capillary phenomenon occurring at the corner 410d.

As shown in FIG. 14, in the downstream ink end sensor connecting flow passage 410, a stepped portion 415 is formed so that the top surface 410f on a downstream side is provided vertically downward from the top surface 410e on an upstream side. With the stepped portion 415, an air pocket 437 is formed above the dam portion 425.

When the ink I that flows in from the ink inlet portion 427 flows into the downstream ink end sensor connecting flow passage 410 toward the ink inflow opening 423, the ink I is caught by the stepped portion 415. Accordingly, the bubble B that is mixed in the ink I is separated from the ink I, and the separated bubble B remains at the top surface 410e above the stepped portion 415 by buoyancy. Further, with this separation action, the bubbles B with a small diameter that originally passes through the narrow flow passage 429 can be grown to a bubble B with a large diameter that does not pass through the narrow flow passage 429, and thus the bubble B is rarely stuck to the ink residual quantity sensor 31.

In the ink cartridge 1 according to the exemplary embodiment, since the dam portion 425 is provided so that the upper end 425a is disposed above the inner-circumferential upper portion 423a of the ink inflow opening 423 in the vertical direction, the ink I passing through the downstream ink end sensor connecting flow passage 410 passes through the dam portion 425, and then flows into the ink inflow opening 423 at the position lower than the upper end 425a of the dam portion 425.

When the bubble B is mixed in the ink I passing through the dam portion 425, buoyancy acts against the bubble B upon the approach to the ink inflow opening 423 by the ink I filled in the downstream ink end sensor connecting flow passage 410, and thus the bubble B rarely enters the ink inflow opening 423. Accordingly, the erroneous detection due to sticking of the bubble B, which is mixed in the ink of the ink containing chambers 370, 390, and 430 to the ink residual quantity sensor 31 can be prevented.

When the ink I of the downstream ink end sensor connecting flow passage 410 gradually decreases, the liquid level gradually falls from the upper end 425a of the dam portion 425. Therefore, when the residual liquid exists in the downstream ink end sensor connecting flow passage 410, there is no case where the liquid level reaches the ink inflow opening 423 earlier. As a result, there is no case where the amount of the residual ink in the ink containing chambers 370, 390, and 430 is erroneously detected as zero, unlike the actual state.

Next, the air communicating path 150 from the air introducing hole 100 to the upper ink containing chamber 370 will be described with reference to FIGS. 8 to 12.

When an inner pressure of the ink cartridge 1 is reduced with a consumption of the ink I in the ink cartridge 1, air (gas) flows from the air introducing hole 100 to the upper ink containing chamber 370 as much as a reduction amount of the stored ink I.

A small hole 102 that is provided in the air introducing hole 100 communicates with an one end of a meandering passage 310 formed on the rear side surface of the cartridge body 10. The meandering passage 310 is a meandering path that is formed lengthwise, and extends from the air introducing hole 100 to the upper ink containing chamber 370 to prevent moisture of ink from evaporating. Further, the other end thereof is connected to the gas-liquid separating filter 70.

A through-hole 322 is formed on a bottom surface of the gas-liquid separating chamber 70a that constitutes the gas-liquid separating filter 70, and communicates with a space 320 formed on the front side surface of the cartridge body 10 through the through-hole 322.

In the gas-liquid separating filter 70, the gas-liquid separating film 71 is disposed between the through-hole 322 and the other end of the meandering passage 310. The gas-liquid separating film 71 has a meshed shape and is made of a textile material that has a high water repellent property and high oil repellent property.

The space 320 is formed on the right upper portion of the upper ink containing chamber 370 when viewed from the front side surface of the cartridge body 10. In the space 320, a through-hole 321 opens above the through-hole 322. The space 320 communicates with an upper connection flow passage 330 formed on the rear side surface through the through-hole 321.

The upper connection flow passage 330 has partial flow passages 333 and 337. The partial flow passage 333 extends from the through-hole 321 along the long side in the right direction, when viewed from the rear side surface so as to pass through the uppermost surface of the ink cartridge 1, that is, the uppermost portion from the gravity direction in a state where the ink cartridge 1 is mounted. The partial flow passage 337 reverses in a reverse portion 335 at the vicinity of the short side, passes through the upper surface of the ink cartridge 1, and extends up to a through-hole 341 formed at the vicinity of the through-hole 321. Further, the through-hole 341 communicates with the ink trap chamber 340 formed on the front side surface.

When the upper connection flow passage 330 is viewed from the rear side surface, a position 336 in which the through-hole 341 is formed and a concave portion 332 which is caved more deeply than the position 336 in the thicknesswise direction of the ink cartridge are provided in the partial flow passage 337 that extends from the reverse portion 335 to the through-hole 341. A plurality of ribs 331 are formed so that the concave portion 332 is partitioned. The partial flow passage 333 that extends from the through-hole 321 to the reverse portion 335 is formed so as to be shallower than the partial flow passage 337 that extends the reverse portion 335 to the through-hole 341.

In the exemplary embodiment, since the upper connection flow passage 330 is formed in the uppermost portion from the gravity direction, the ink I does not normally flow to the air introducing hole 100 beyond the upper connection flow passage 330. Moreover, the upper connection flow passage 330 has as a sufficiently wide thickness much as the ink I does not flow backward by the capillary phenomenon, and the concave portion 332 is formed in the partial flow passage 337. Accordingly, it is easy to catch the ink I that flows backward.

The ink trap chamber 340 is a rectangular parallelepiped space that is formed in a corner of the right upper portion of the cartridge body 10 when viewed from the front side surface. As shown in FIG. 12, the through-hole 341 opens to the vicinity of an inner corner of the left upper portion of the ink trap chamber 340 when viewed from the front side surface. Further, in a front corner of the right lower portion of the ink trap chamber 340, a notch 342 is formed in the manner that a part of the rib 10a, which serves as a wall, is notched. Accordingly, the ink trap chamber 340 communicates with the connecting buffer chamber 350 through the notch 342.

The ink trap chamber 340 and the connecting buffer chamber 350 are air chambers that are provided so as to expand a capacity of the way of the air communicating path 150. For this reason, even when the ink I flows backward from the upper ink containing chamber 370, the ink I remains in the ink trap chamber 340 and the connecting buffer chamber 350 so that the ink I does not flow into the air introducing hole 100 any more. The detailed role of the ink trap chamber 340 and the connecting buffer chamber 350 will be described below.

The connecting buffer chamber 350 is a space that is formed below the ink trap chamber 340. A depressurization hole 110 for extracting air when ink is injected is provided on the bottom surface 352 of the connecting buffer chamber 350. The through-hole 351 opens in the thicknesswise direction in the vicinity of the bottom surface 352 and in the lower portion in the down most gravity direction when mounted on the ink jet printing apparatus. Accordingly, through the through-hole 351, the connecting buffer chamber 350 communicates with a connecting flow passage 360 formed on the rear side surface.

The connecting flow passage 360 extends in a middle upward direction when viewed from the rear side surface, and communicates with the upper ink containing chamber 370 through a through-hole 372 that is in the downstream end of the air communicating path 150 opening in the vicinity of the bottom wall of the upper ink containing chamber 370. The air communicating path 150 according to the exemplary embodiment is constituted from the air introducing hole 100 to the connecting flow passage 360. The connecting flow passage 360 is slimly formed so as not to form a meniscus and flow the ink backward.

In the ink cartridge 1 according to the exemplary embodiment, as shown in FIG. 8, the non-containing chamber 501 that does not contain the ink I is shown when viewed from the front side surface of the cartridge body 10 in addition to the above-described ink containing chambers (the upper ink containing chamber 370, the lower ink containing chamber 390, and the buffer chamber 430), the air chambers (the ink trap chamber 340 and the connecting buffer chamber 350), and the ink guide paths (the upstream ink end sensor connecting flow passage 400 and the downstream ink end sensor connecting flow passage 410).

When viewed from the front side surface of the cartridge body 10, the non-containing chamber 501 is partitioned in an area close to the hatched left side surface so as to be inserted between the upper ink containing chamber 370 and the lower ink containing chamber 390.

In addition, in the non-containing chamber 501, an air introducing hole 502 that passes through the rear side surface is provided at the left upper corner in the inner area thereof so as to communicate with open air through the air introducing hole 502.

When the ink cartridge 1 is depressurized and packed, the non-containing chamber 501 serves as a deaerating chamber in which a deaerating negative pressure is accumulated. Since an inner atmospheric pressure of the cartridge body 10 is maintained equal to or less than the prescribed value by a negative pressure suction force of the non-containing chamber 501 and the depressurized package, it is possible to supply the ink I that has dissolved air a little.

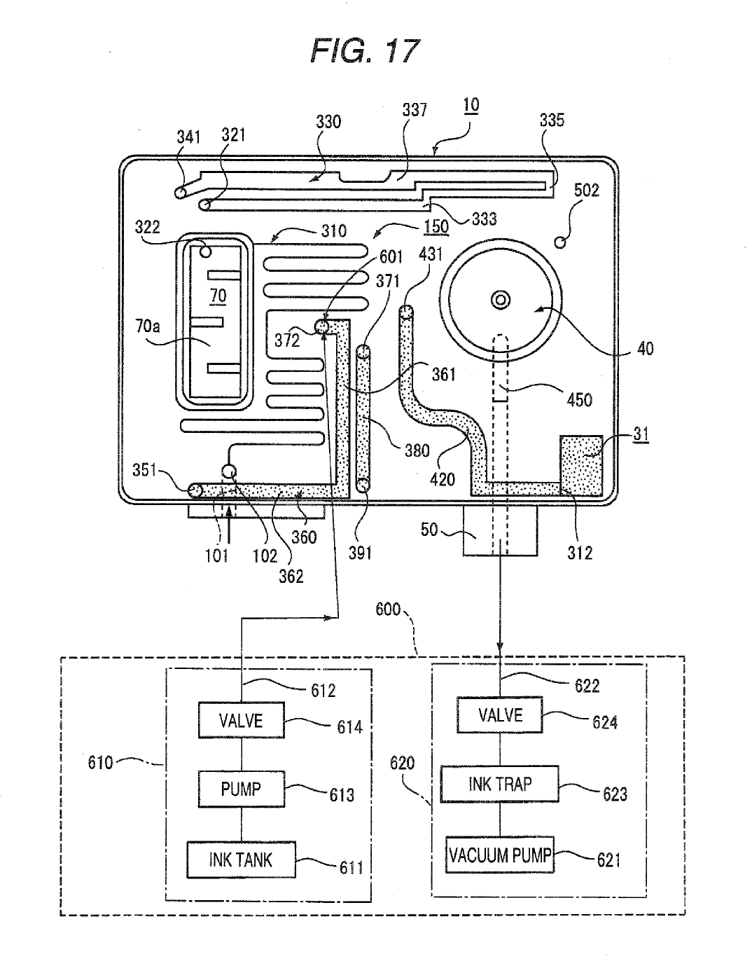

Next, when the ink I in the ink cartridge 1 described above is exhausted or is lowered to a predetermined value, a method of injecting the ink I into the used ink cartridge 1 according to an exemplary embodiment will be described with reference to FIG. 17.

First, a configuration of an ink re-injecting apparatus used for the injecting method according to the exemplary embodiment will be described.

As shown in FIG. 17, an ink re-injecting apparatus 600 includes an ink injecting mechanism 610 connected to an injection port 601, which is opened by a punching process in the ink cartridge 1, and a vacuum sucking mechanism 620 connected to the ink supply portion 50 of the cartridge body 10.

The ink injecting mechanism 610 includes an ink tank 611 for storing the filled ink I, a pump 613 for sending the ink I stored in the ink tank 611 to a flow passage 612 connected to the injection port 601, and a valve 614 for opening/closing the flow passage 612 between the pump 613 and the injection port 601.

The vacuum sucking mechanism 620 includes a vacuum pump 621 for generating a negative pressure required for the vacuum sucking; a connecting flow passage 622 for allowing the negative pressure generated by the vacuum pump 621 to apply to the ink supply portion 50; an ink trap 623 for being provided in the connecting flow passage 622, catching/collecting the ink I, which flows from the cartridge body 10 to the connecting flow passage 622 by the vacuum sucking, and protecting the vacuum pump 621 against ink mist or the like; and a valve 624 for opening/closing the connecting flow passage 622 between the ink trap 623 and the ink supply portion 50.

In the exemplary embodiment, in consideration of a configuration or a function of the ink cartridge 1, a position in which the injection port 601 communicating with the upper ink containing chamber 370 is formed in air communicating path 150 is determined in the vicinity of a position opposite to the through-hole 372 which is positioned in a downstream end of the connecting flow passage 360 constituting a part of the air communicating path 150.

The injection port 601 opposite to the through-hole 372 is bored through the outer surface film 60 (film member) covering the rear side surface of the cartridge body 10 to conform with the through-hole 372. In the front end portion of the flow passage 612 inserted into the injection port 601, for example, a sealing member or the like for air-tightly allowing the flow passage 612 to connect to the through-hole 372 is provided by tightly pressing against the through-hole 372 and attaching to the wall surface of the circumference of the through-hole 372.

The injection port 601 communicating with the upper ink containing chamber 370 is formed in the air communicating path 150 positioned on more upstream than the upper ink containing chamber 370. The position on which the injection port 601 is formed is not limited to the exemplary embodiment.

For example, the injection port 601 may be formed by boring a hole through the outer surface film 60 so as to conform with the connecting flow passage 360 constituting a part of the air communicating path 150, or by peeling off the outer surface film 60. Alternatively, the injection port 601 may be formed by peeling off the outer surface film 60 and the gas-liquid separating film 71 so as to conform with the through-hole 322 opening to the gas-liquid separating chamber 70a constituting the gas-liquid separating filter 70.

Moreover, the injection port 601 may be formed by removing the cover member 20 from the ink cartridge 1, exposing the film 80 covering the front side surface of the cartridge body 10, and boring a hole through the film 80 so as to conform with the through-hole 351 that is positioned in the upper end of the connecting flow passage 360 constituting a part of the air communicating path 150.

According to the exemplary embodiment, the used ink cartridge 1 is recovered as a reusable ink cartridge (liquid container) by, first, an injecting forming step of forming the injection port 601 communicating with the upper ink containing chamber 370 in the air communicating path 150, a vacuum sucking step of sucking and removing the residual ink and residual air remaining in the inside from the ink supply portion 50 by the vacuum sucking mechanism 620, a liquid injecting step of injecting a predetermined amount of ink from the injection port 601 by the ink injecting mechanism 610, and a sealing step of sealing the injection port 601 after the liquid injecting step.

Specifically, the sealing step is a process of forming a sealing portion. Specifically, the injection port 601 is air-tightly closed by attaching or welding a sealing film, a tape or the like, or by putting a stopper or the like.

In the above-described ink injecting method of the ink cartridge according to the exemplary embodiment, a process of injecting the ink I into the ink cartridge 1 is performed by the step of opening the injection port 601 for injecting the ink I to the outer surface film 60 so as to communicate with the upper ink containing chamber 370, and the step of sealing the injection port 601 after injecting the ink I, which are all the simple steps. As a result, a processing cost can be reduced and it is not difficult to re-fill an ink cartridge.

In the exemplary embodiment, the vacuum sucking step of sucking and removing the residual ink and residual air remaining in the inside from the ink supply portion 5 is provided. As a result, when the liquid injecting step of injecting the predetermined amount of the ink I from the injection port 601 is performed, the ink guide paths 380, 420, and 440 or the ink containing chambers of the cartridge body 10 are controlled under the depressurization environment, and thus all the ink guide paths including the ink supply portion 50 as well as the ink containing chambers 370, 390, and 430 can effectively refill with the injected ink I.

Bubbles that are mixed when the ink I is injected can be extracted from the ink supply portion 50 to the outside by means of the vacuum sucking, or inflow bubbles can be dissolved/disappeared in the liquid under the depressurization environment in the container formed by means of the vacuum sucking.

Moreover, When the bubble B is mixed in the ink I passing through the dam portion 425, buoyancy acts against the bubble B upon the approach to the ink inflow opening 423 by the ink I injected into the downstream ink end sensor connecting flow passage 410, and thus the bubble B rarely enters the ink inflow opening 423. Accordingly, the erroneous detection due to sticking of the bubble B, which is mixed in the ink of the ink containing chambers 370, 390, and 430, to the ink residual quantity sensor 31 can be prevented.

When the refilled ink cartridge refilled by such an ink injecting method is provided, the expected life span of the product as an ink cartridge container is increased. As a result, the resource can be saved and the environmental pollution can be prevented. Further, since a cost required for the re-filling is inexpensive, and an ink cartridge is provide at a low price, a running cost for the ink jet printing apparatus can be reduced.

In addition, in the above-described ink injecting method of the ink cartridge according to the exemplary embodiment, a cleaning liquid can be injected in the cartridge body 10 from the injection port 601 to clean/remove coagulated ink in the inside of the container between the vacuum sucking step and the liquid injecting step. It is not required that the processing order of the vacuum sucking step and the liquid injecting step are definitely set. For example, while performing the vacuum sucking step, the liquid injecting step may be performed together.

The ink re-injecting apparatus 600 used to perform the ink injecting step according to the exemplary embodiment may be substituted by an apparatus that can be easily obtained.

For example, the ink injecting mechanism 610 may be substituted by an injecting apparatus constituted by a cylinder and a piston for a syringe, or may be substituted by a supplementary bottle containing supplementary ink in a deformable pet bottle.

In the liquid container according to the exemplary embodiment, the configuration of the container body, the liquid containing portion, the liquid supply portion, the liquid guide path, the air communicating path, the liquid detecting portion, the dam portion, and the like is not limited to the exemplary embodiment, but may be modified in various forms without departing from the gist of the invention.

A use of the liquid container according to the invention is not limited to the above-described ink cartridge of the ink jet printing apparatus. The liquid container can be applied to various liquid consuming apparatus including a liquid ejecting head ejecting a small amount of liquid drop, and the like.

Specific examples of the liquid consuming apparatus include an apparatus having a color material ejecting head used for manufacturing a color filter such as a liquid crystal display, an apparatus having an electrode material (conductive paste) ejecting head used for forming an electrode such as an organic EL display, or a field emission display (FED), an apparatus having a bioorganic matter ejecting head used for manufacturing a biochip, an apparatus having a simple ejecting head used for a precision pipette, a printing apparatus, a micro dispenser, and the like.

The entire disclosure of Japanese Patent Application Nos' 2006-220759 filed on Aug. 12, 2006 and 2006-220755 filed on Aug. 11, 2006 are expressly incorporated by reference herein.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the sprit and scope of the invention.

What is claimed is:

1. A method of injecting a liquid into a liquid container detachably mounted on a liquid consuming device, the liquid container comprising a liquid containing portion, a liquid supply portion connectable to the liquid consuming device, a liquid guide path for guiding the liquid stored in the liquid containing portion to the liquid supply portion, an air communicating path communicating the liquid containing portion with air, a liquid detection unit provided in the liquid guide path and for outputting different signals between in a case where the liquid guide path is filled with the liquid and in a case where the liquid guide path includes air entered thereinto, and a dam portion provided in the liquid guide path so that an upper end thereof is disposed vertically above an inner-circumferential upper portion of a liquid inflow opening for allowing the liquid to flow in the liquid detection unit, the method comprising the steps of:
forming an injection port communicated with the liquid containing portion in the air communicating path;
injecting a predetermined amount of the liquid from the injection port; and
sealing the injection port after injecting the liquid.

2. The method according to claim 1, further comprising depressurizing an inside of the liquid containing chamber before injecting the liquid.

3. The method according to claim 2, wherein the inside of the liquid containing chamber is depressurized through the liquid supply portion.

4. The method according to claim 1, wherein the injection port is formed in a downstream end of the air communicating path.

5. A liquid container detachably mounted on a liquid consuming device includes:
a liquid containing portion;
a liquid supply portion connectable to the liquid consuming device;
a liquid guide path for guiding the liquid stored in the liquid containing portion to the liquid supply portion;
an air communicating path communicating the liquid containing portion with air;
a liquid detection unit provided in the liquid guide path and for outputting different signals between in a case where the liquid guide path is filled with the liquid and in a case where the liquid guide path includes air entered thereinto; and
a dam portion provided in the liquid guide path so that an upper end thereof is disposed vertically above an inner-circumferential upper portion of a liquid inflow opening for allowing the liquid to flow in the liquid detection unit,
wherein an injection port communicated with the liquid containing portion is formed in the air communicating path, a predetermined amount of the liquid is injected from the injection port, and the injection port is sealed after injecting the liquid.

6. The liquid container according to claim 5, wherein at least a part of a bottom surface of the liquid guide path between the liquid inflow opening and the dam portion is vertically inclined toward the liquid inflow opening.

7. The liquid container according to claim 5, wherein a narrow flow passage causing a capillary phenomenon of the liquid is formed in the liquid guide path.

8. The liquid container according to claim 7, wherein a plurality of the narrow flow passages are formed in parallel.

9. The liquid container according to claim 7, wherein the narrow flow passage has a rectangular section.

10. The liquid container according to claim 9, wherein an inlet portion on an uppermost stream side of the liquid guide path is a round hole having a diameter larger than a short side length of the rectangular section of the narrow flow passage.

11. The liquid container according to claim 7, wherein at least one inner wall surface of the narrow flow passage is an inner wall surface of the liquid guide path.

12. The liquid container according to claim 5, wherein a stepped portion in which a top surface on a downstream side is disposed vertically downward rather than that on an upstream side is disposed in the liquid guide path.

13. The liquid container according to claim 5, further comprising a differential pressure valve which is disposed in the liquid flow passage, which is normally urged to be a closed state, and which is changed from the closed state to an opened state when a differential pressure between a side of the liquid supply portion and a side of the liquid containing portion is equal to or more than a predetermined value.

14. A liquid container detachably mounted on a liquid consuming device includes:
a liquid containing portion;
a liquid supply portion connectable to the liquid consuming device;
a liquid guide path communicating the liquid containing portion and the liquid supply portion with each other;
an air communicating path communicating the liquid containing portion with air;
a liquid detection unit provided in the liquid guide path and for outputting different signals between in a case where the liquid guide path is filled with the liquid and in a case where the liquid guide path includes air entered thereinto;
a dam portion provided in the liquid guide path so that an upper end thereof is disposed vertically above an inner-circumferential upper portion of a liquid inflow opening connecting a part of the liquid guide path to the liquid detection unit;
a film member forming at least a part of the air communication path; and
a sealing portion at which an injection port communicated with the liquid containing portion and formed on the film member is sealed.

15. The liquid container according to claim 14, wherein the sealing portion is formed by a film or a tape.

16. The liquid container according to claim 14, wherein the liquid container contains the liquid with such an amount that the liquid can flow over the dam portion.
